(19) United States
(12) Patent Application Publication
(10) Pub. No.: US 2018/0289008 A1
(43) Pub. Date: Oct. 11, 2018

(54) METHODS FOR WILDFIRE CONTROL, INVASIVE PLANT CONTROL, AND RESIDUAL CONTROL OF INVASIVE PLANTS

(71) Applicant: Bayer CropScience LP, Research Triangle Park, NC (US)

(72) Inventors: Derek J. SEBASTIAN, Greeley, CO (US); David R. SPAK, Cary, NC (US); Harold E. QUICKE, Windsor, CO (US)

(21) Appl. No.: 15/943,987

(22) Filed: Apr. 3, 2018

Related U.S. Application Data
(60) Provisional application No. 62/482,318, filed on Apr. 6, 2017.

(51) Int. Cl. A01N 43/68; A01N 43/40; A01N 43/54; A01N 43/50

(52) U.S. Cl. CPC A01N 43/68; A01N 43/50; A01N 43/54; A01N 43/40

(57) ABSTRACT

A method for wildfire control in a habitat that contains or could contain plants susceptible to wildfire includes applying to the habitat a composition containing a cellulose biosynthesis inhibitor. A method of controlling invasive plants in a habitat includes applying to the habitat a composition containing a cellulose biosynthesis inhibitor. A method for residual control of invasive plants in a habitat includes applying to the habitat a composition containing a cellulose biosynthesis inhibitor.

### CROSS-REFERENCE TO RELATED APPLICATIONS

This application claims priority to U.S. Provisional Patent Application 62/482,318, filed Apr. 6, 2017, which is incorporated by reference in its entirety.

### BACKGROUND OF INVENTION

### Field of the Invention

The invention relates generally to methods for burndown and residual control of plants and wildfire control in, for example, non-crop areas by applying to plants or habitats thereof a composition having a cellulose biosynthesis inhibitor.

### Background Art

Invasive species cost the United States billions of dollars annually and disrupt natural ecosystems. Across the U.S., invasive plants are estimated to occur on 7 million acres of national park lands, and at least 1.5 million acres are severely infested. In addition to federal lands, state and private lands are also plagued with invasive plants and may have even higher infestation rates.

Invasive plants can cause wildfires to occur more often and burn more intensely as a significant and potentially dry fuel source. The economic impact of invasive plants is estimated at more than $34 billion per year, and the costs continue to grow. Thus, invasive plants cause major negative impacts to ecosystem and economy.

Exemplary grass weeds, e.g., cheatgrass (downy brome (Bromus tectorum L.)), medusahead, and jointed goatgrass, are annual grass weeds that are invading the lands of the western United States. These exotic, invasive grass species negatively affect shrub-steppe habitats and croplands of the western United States by, e.g., increasing wildfire frequencies, thereby removing long-lived perennial species, thus facilitating further invasion by invasive grass weeds and/or by out-competing agricultural crops for water resources.

Downy brome is a highly competitive winter annual grass and is considered one of the most problematic invasive species in rangeland. It is estimated that nearly 22 million hectares of the western United States rangeland are infested. Downy brome produces significant amounts of dead, above-ground biomass, e.g., thatch, which can accelerate wildfire in both rangeland and in cropland. The dead, above-ground biomass comprises a fine, dense mat of highly flammable fuel susceptible to ignition and thus accelerating fire cycles. Accordingly, fire size, intensity, and frequency have increased dramatically with the expansion of annual grass weed infestations. In addition to disrupting ecology and ecosystem, fire can be devastating to rangeland and standing crops, and leaves the soil more vulnerable to erosion and runoff.

Although herbicides are available, most are expensive, vary in effectiveness, and do not reduce the seed bank of invasive plants. In addition, seed bank longevity is typically underestimated and some seeds, e.g., downy brome seeds, can remain in the soil for years. There are limited herbicide options that provide the long-term control necessary to deplete the soil seed bank of invasive weed seed and to decrease wildfire frequency.

### SUMMARY OF INVENTION

A first aspect of the present invention relates to a method for wildfire control in a habitat that contains or could contain plants susceptible to wildfire, including applying to the habitat a composition containing a cellulose biosynthesis inhibitor.

A second aspect of the present invention relates to a method of controlling invasive plants in a habitat, including applying to the habitat a composition containing a cellulose biosynthesis inhibitor.

A third aspect of the present invention relates to a method for residual control of invasive plants in a habitat, including applying to the habitat a composition containing a cellulose biosynthesis inhibitor.

A fourth aspect of the present invention relates to the method of any one of the first-the third aspects, in which the cellulose biosynthesis inhibitor is applied to a plant, wherein the plant is at least one selected from the group consisting of blue grama (Bouteloua gracilis), buffalo grass (Bouteloua dactyloides), western wheatgrass (Pascopyrum smithii), bluebunch wheatgrass (Pseudoroegneria spicata), Griffith's wheatgrass (Agropyron griffithsii), sedges (Carex spp.), needle-and-thread (Hesperostipa comata), Columbia needlegrass (Achnatherum nelsonii), green needlegrass (Nassella viridula), Indian ricegrass (Oryzopsis hymenoides), big bluestem (Andropogon gerardi), little bluestem (Schizachyrium scoparium), sand bluestem (Andropogon hallii), switchgrass (Panicum virgatum), Parry oatgrass (Danthonia parryi), timber oatgrass (Danthonia intermedia), mountain muhly (Muhlenbergia montana), slim-stem muhly (Muhlenbergia filiculmis), Kentucky bluegrass (Poa pratensis), Sandberg bluegrass (Poa secunda), mountain brome (Bromus marginatus), nodding brome (Bromus anomalus), Indiangrass (Sorghastrum nutans), Idaho fescue (Festuca idahoensis), eastern gammagrass (Tripsacum dactyloides), prairie junegrass (Koeleria macrantha), sand lovegrass (Eragrostis trichodes), slender wheatgrass (Elymus trachycaulus), common mullein (Verbascum thapsus), common teasel (Dipsacus fullonum), curly dock (Rumex crispus), Dalmatian toadflax (Linaria dalmatica), diffuse knapweed (Centaurea diffusa), downy brome (Bromus tectorum), feral rye (Secale cereale), halogeton (Halogeton glomeratus), marestail (Conyza Canadensis), musk thistle (Carduus nutans), Louisiana sage (Artemisia ludoviciana), fringed sage (Artemisia frigida), common sunflower (Helianthus annuus), sulphur-flower buckwheat (Eriogonum umbellatum), and hairy goldenaster (Heterotheca villosa), Canada thistle (Cirsium arvense), teasel (Dipsacus spp.), Houndstongue (Cynoglossum officinale), scotch thistle (Onopordum acanthium), field bindweed (Convolvulus arvensis), American peavine (Vicia americana), and scarlet globemallow (Sphaeralcea coccinea).

A fifth aspect of the present invention relates to the method of any one of the first-the fourth aspects, in which the plant is at least one selected from the group consisting of common mullein (Verbascum thapsus), common teasel (Dipsacus fullonum), curly dock (Rumex crispus), Dalmatian toadflax (Linaria dalmatica), diffuse knapweed (Centaurea diffusa), downy brome (Bromus tectorum), feral rye (Secale cereale), halogeton (Halogeton glomeratus), marestail (Conyza Canadensis), musk thistle (Carduus nutans), Louisiana sage (Artemisia ludoviciana), fringed sage (Artemisia frigida), common sunflower (Helianthus annuus), sulphur-flower buckwheat (Eriogonum umbellatum), and hairy goldenaster (Heterotheca villosa), Canada thistle (Cirsium arvense), teasel (Dipsacus spp.), Houndstongue (Cynoglossum officinale), scotch thistle (Onopordum acanthium), and field bindweed (Convolvulus arvensis).

A sixth aspect of the present invention relates to the method of any one of the first-the fifth aspects, in which the plant is selected from the group consisting of Dalmatian toadflax (Linaria dalmatica) and downy brome (Bromus tectorum).

A seventh aspect of the present invention relates to the method of any one of the first-the sixth aspects, in which the habitat is a non-crop area.

An eighth aspect of the present invention relates to the method of any one of the first-the seventh aspects, in which the habitat is a rangeland or a pastureland.

A ninth aspect of the present invention relates to the method of any one of the first-the eighth aspects, in which the cellulose biosynthesis inhibitor is applied at a rate of 1-1,000 g ai ha-1.

A tenth aspect of the present invention relates to the method of any one of the first-the ninth aspects, in which the composition further contains at least one additional herbicide.

An eleventh aspect of the present invention relates to the method of the tenth aspect, in which the at least one additional herbicide is applied at a rate of 10-2,000 g ai ha-1.

A twelfth aspect of the present invention relates to the method of any one of the first-the eleventh aspects, in which the cellulose biosynthesis inhibitor is indaziflam.

A thirteenth aspect of the present invention relates to the method of any one of the tenth-the twelfth aspects, in which the at least one additional herbicide is selected from the group consisting of aminopyralid, aminocyclopyrachlor, imazapic, and picloram.

A fourteenth aspect of the present invention relates to the method of any one of the first-the thirteenth aspects, in which the composition contains indaziflam and aminopyralid.

A fifteenth aspect of the present invention relates to the method of any one of the first-the thirteenth aspects, in which the composition contains indaziflam and aminocyclopyrachlor.

A sixteenth aspect of the present invention relates to the method of any one of the first-the thirteenth aspects, in which the composition contains indaziflam and imazapic.

A seventeenth aspect of the present invention relates to the method of any one of the first-the thirteenth aspects, in which the composition contains indaziflam and picloram.

An eighteenth aspect of the present invention relates to the method of any one of the first-the seventeenth aspects, further includes reducing germinating seedlings of the plant.

A nineteenth aspect of the present invention relates to the method of any one of the first-the eighteenth aspects, in which the applying is once a year.

A twentieth aspect of the present invention relates to the method of any one of the first-the eighteenth aspects, in which the applying is every two years.

A twenty-first aspect of the present invention relates to the method of any one of the first-the eighteenth aspects, in which the applying is every three years.

A twenty-second aspect of the present invention relates to the method of any one of the first-the eighteenth aspects, in which the applying is every four years.

A twenty-third aspect of the present invention relates to the method of any one of the first-the eighteenth aspects, in which the applying is every five years.

A twenty-fourth aspect of the present invention relates to the method of any one of the first-the twenty-third aspects, in which a thatch of the plant is reduced after the applying.

Other aspects and advantages of the invention will be apparent from the following description and the appended claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows Dalmatian toadflax and downy brome control represented as a percent of non-treated plots 1, 2, 3, and 4 YAT. Application timings were June and August. At the June and August application timings, Dalmatian toadflax were in the flowering and re-growth stages, respectively; however, both timings were prior to downy brome emergence (PRE). Letters indicate differences among herbicide treatments across both timings and years, using least squares means (P<0.05). Herbicide treatment rates are as follows: aminocyclopyrachlor (ACP, 57 g·ai·ha⁻¹), imazapic (105 g·ai·ha⁻¹), indaziflam (Indaz, 58 g·ai·ha⁻¹), picloram (Pic, 227 g·ai·ha⁻¹), non-treated.

FIG. 2 shows another embodiment in accordance with the present disclosure.

FIG. 3A-3I show response of nine invasive species found in non-crop areas to aminocyclopyrachlor, aminopyralid, and indaziflam. Dose response curves were fit using four parameter log-logistic regression. Mean values of six replications are plotted. Vertical lines represent the herbicide dose resulting in 50% reduction in dry biomass (GR₅₀) for each species and herbicide.

FIGS. 4A-4D show other embodiments in accordance with the present disclosure.

FIG. 5 shows Sites 1 and 2 percent invasive winter annual grass control (downy brome, feral rye, Japanese brome) compared with the non-treated 1 and 2 YAT. Five application timings were evaluated including early PRE (EPRE, July year 1), PRE (August year 1), early POST (EPOST, December year 1), POST (February year 2), and late POST (LPOST, April year 2). Letters indicate differences among herbicide treatments across all five timings and years, using least squares means (P<0.05). Herbicide treatment rates at each timing are as follows: indaziflam at 44, 73, and 102 g·ai·ha⁻¹ and imazapic at 123 g·ai·ha⁻¹. All POST treatments included 420 g·ae·ha⁻¹ glyphosate as the burndown.

### DETAILED DESCRIPTION

Invasive winter annual grass invasions are increasing at an alarming rate. Invasive winter annual grasses displace native vegetation that is critical habitat for wildlife and livestock and increase fire frequency and intensity due to the dense accumulation of fine fuel. Although land managers have been attempting for decades to recover these sites dominated by invasive winter annual grasses, few have been consistently successful. As these natural ecosystems continue to shift from perennial-grass domination to invasive winter annual grass-domination, the necessity for new management tools continues to increase.

Methods of the present disclosure may be applied to over 300 rangeland weeds and plants in the U.S. including blue grama (Bouteloua gracilis), buffalo grass (Bouteloua dactyloides), western wheatgrass (Pascopyrum smithii), bluebunch wheatgrass (Pseudoroegneria spicata), Griffith's wheatgrass (Agropyron griffithsii), sedges (Carex spp.), needle-and-thread (Hesperostipa comata), Columbia needlegrass (Achnatherum nelsonii), green needlegrass (Nassella viridula), Indian ricegrass (Oryzopsis hymenoides), big bluestem (Andropogon gerardi), little bluestem (Schizachyrium scoparium), sand bluestem (Andropogon hallii), switchgrass (Panicum virgatum), Parry oatgrass (Danthonia parryi), timber oatgrass (Danthonia intermedia), mountain muhly (Muhlenbergia montana), slim-stem muhly (Muhlenbergia filiculmis), Kentucky bluegrass (Poa pratensis), Sandberg bluegrass (Poa secunda), mountain brome (Bromus marginatus), nodding brome (Bromus anomalus), Indiangrass (Sorghastrum nutans), Idaho fescue (Festuca idahoensis), eastern gammagrass (Tripsacum dactyloides), prairie junegrass (Koeleria macrantha), sand lovegrass (Eragrostis trichodes), slender wheatgrass (Elymus trachycaulus), common mullein (Verbascum thapsus), common teasel (Dipsacus fullonum), curly dock (Rumex crispus), Dalmatian toadflax (Linaria dalmatica), diffuse knapweed (Centaurea diffusa), downy brome (Bromus tectorum), feral rye (Secale cereale), halogeton (Halogeton glomeratus), marestail (Conyza Canadensis), musk thistle (Carduus nutans), Louisiana sage (Artemisia ludoviciana), fringed sage (Artemisia frigida), common sunflower (Helianthus annuus), sulphur-flower buckwheat (Eriogonum umbellatum), and hairy goldenaster (Heterotheca villosa), Canada thistle (Cirsium arvense), teasel (Dipsacus spp.), Houndstongue (Cynoglossum officinale), scotch thistle (Onopordum acanthium), field bindweed (Convolvulus arvensis), American peavine (Vicia americana), and scarlet globemallow (Sphaeralcea coccinea). The most invasive and problematic weeds include Dalmatian toadflax, diffuse knapweed, downy brome, and musk thistle.

Downy brome (Bromus tectorum L.) and Dalmatian toadflax (Linaria dalmatica) have emerged as two of the most wide-spread and problematic, with average annual spread rates of 14% and 19%, respectively. Disturbance favors these particular invasive plants so they commonly invade degraded areas, such as roadsides, abandoned lots and crop fields, gravel pits, clearings, and overgrazed rangeland. Downy brome, an invasive winter annual grass, has rapidly spread throughout many regions of the U.S. displacing native vegetation and altering fire frequency and intensity. It has been estimated that over 22 million hectares of the western United States are infested with downy brome. Downy brome germinates in the fall and early spring, exploiting moisture and nutrients before native plant communities begin active growth in the spring. Downy brome seeds are tolerant to temperature and moisture stress and can remain viable for up to 5 years. Unlike downy brome, Dalmatian toadflax is a short-lived herbaceous perennial plant. This species has escaped cultivation and is most commonly found in semi-arid areas, on course textured, gravelly soils. It is a self-incompatible species contributing to its high level of genetic variability. Dalmatian toadflax produces large amounts of seed that can remain viable in the soil for approximately 10 years. Once established, this high seed production along with aggressive vegetative propagation enables Dalmatian toadflax to spread rapidly and to dominate and persist.

Other invasive broadleaf weeds in non-crop areas resulting in major economic and ecological impacts include diffuse knapweed (Centaurea diffusa Lam), musk thistle (Carduus nutans L.), curly dock (Rumex crispus L.), common mullein (Verbascum thapsus L.), halogeton (Halogeton glomeratus (M. Bieb.) C. A. Mey.), marestail (Conyza canadensis (L.) Cronquist), and common teasel (Dipsacus fullonum L.). There are currently limited management options that provide long-term control of these weeds.

Among the available control, e.g., mechanical, cultural, biological, and chemical, strategies for invasive weed control in non-crop areas, herbicides are the primary method. Synthetic auxin or growth regulator herbicides, such as aminocyclopyrachlor (METHOD, Bayer CropScience), aminopyralid (MILESTONE, Dow AgroSciences), and picloram (TORDON, Dow AgroSciences) are commonly recommended residual broadleaf herbicides, while imazapic (PLATEAU, BASF) has been the primary herbicide for downy brome control because it has some residual activity, and is relatively selective at low use rates. Several other herbicides including glyphosate and rimsulfuron have been used for short-term downy brome control. None of these herbicides have provided long-term control of invasive weeds when used alone, resulting in rapid re-infestations.

This lack of residual control and resulting seedling recruitment could be attributed to the chemical properties of these herbicides. For example, the average water solubility and Log K_{ow} (pH 7) of aminocyclopyrachlor, aminopyralid, imazapic, and picloram are 4,200 mg L-1 (−2.48), 207,000 mg·L-1 (−2.87), 2,200 mg L-1 (0.01), and 200,000 mg L-1 (1.18), respectively. This indicates that these herbicides are highly water soluble with high leaching potentials, thus ultimately resulting in a decrease of the herbicide concentration available in the soil solution for plant uptake beyond the initial year of application. Desorption hysteresis with aminocyclopyrachlor and picloram showed that a small amount of herbicide sorbed is resistant to desorption and irreversibly bound to soils.

Another factor to be considered for long-term control of invasive plants is the soil seed bank. The longevity of weed seeds in the soil for the species listed above are all >2 years. Therefore, there is a need for new herbicides that have a decreased leaching potential, and provide the soil residual control necessary to deplete the soil seed bank. Residual control for multiple growing seasons would also provide native perennial plants a competitive advantage for re-establishment. It has been found that methods using indaziflam meets these needs.

Pre-emergence herbicides may be referred to as “residual herbicides,” which means they provide extended control of germinating or newly emerged weeds. Herbicides with residual activity, therefore, would be desirable for control of germinating seedlings. While aminocyclopyrachlor, aminopyralid, and picloram have residual activity, their residual activity, however, is less than that of indaziflam.

The compound, indaziflam, used in the present disclosure is described in, for example, U.S. Pat. No. 8,114,991, which is hereby incorporated by reference in its entirety. The compound taught by U.S. Pat. No. 8,114,991 is described therein as having herbicidal properties. See U.S. Pat. No. 8,114,991 at, for example, column 62, line 22 to column 72, line 43.

Indaziflam's International Union of Pure and Applied Chemistry (IUPAC) name is N2-[(1R,2S)-2,3-dihydro-2,6-dimethyl-1H-inden-1-yl]-6-[(1RS)-1-fluoroethyl]-1,3,5-triazine-2,4-diamine. Indaziflam is written chemically as C₁₆H₂₀FN₅.

Indaziflam is an alkylazine compound characterized as a cellulose biosynthesis inhibitor (CBI), belonging to Weed Science Society of America (“WSSA”) Mode of Action group 29. Cellulose biosynthesis inhibitor herbicides affect synthesis of the cellulose needed for cell walls in susceptible plants, thereby inhibiting cell division. These herbicides are absorbed through susceptible plants' roots and shoot tissues and inhibit root and shoot growth. Additional cellulose biosynthesis inhibitors include herbicides belonging to benzamide (WSSA group 21), nitrile (WSSA group 20), and triazolocarboxamides (WSSA group 28) classes of chemicals. For example, cellulose biosynthesis inhibitors of the benzamide family include isoxaben. Cellulose biosynthesis inhibitors of the nitrile family include dichlobenil and chlorthiamid. Cellulose biosynthesis inhibitors of the triazolocarboxamide family include flupoxam.

Commercially available herbicides incorporating indaziflam as their active ingredient include, for example, Alion®, Esplanade® EZ, Esplanade® 200 SC, Specticle® G, Specticle® FLO, Specticle® Total, Specticle® 20 WSP, Marengo®, and DuraZone®.

Indaziflam is useful as a selective, pre-emergence herbicide for annual grasses and broadleaf weeds. Indaziflam has been approved for use on residential and commercial property, such as golf courses, lawns, walkways, cemeteries, evergreen nurseries, and landscaping projects.

As a cellulose-biosynthesis inhibitor, indaziflam has been found to have a unique mode of action for non-crop areas with residual soil activity and broad spectrum pre-emergence (PRE) control. In addition, indaziflam is more lipophilic with a water solubility of 3.6 mg L⁻¹ and log K_{ow} of 2.8 (pH 7) than aminocyclopyrachlor, aminopyralid, imazapic, and picloram, which have water solubility in the range of (2,200 to 207,000 mg L⁻¹) and log K_{ow} (−2.87 to 1.18). Thus, indaziflam may have less herbicide dilution in the soil profile and longer-term soil residual activity and is therefore especially useful in methods according to the present invention. Further, use of indaziflam is economical because the recommended non-crop use rates are relatively low for indaziflam, e.g., 73 to 102 g ai ha⁻¹, which is comparable to imazapic (70 to 123 g ai ha⁻¹), aminocyclopyrachlor (70 to 140 g ae ha⁻¹), aminopyralid (53 to 123 g·ae·ha⁻¹), and is much less than picloram, (140 to 1,121 g·ae·ha⁻¹). The application rates for indaziflam in the present invention may be 1 to 1000, 10 to 500, 15 to 250, 25 to 200, or 50 to 150 g·ae·ha⁻¹. Indaziflam may be used in combination with one or more additional herbicides that may include imazapic, aminocyclopyrachlor, aminopyralid, and/or picloram. The application rates for the additional herbicide may be 10 to 2000, 20 to 1500, 50 to 1200, 60 to 1000, or 70 to 500 g·ae·ha⁻¹. The weight ratios of indaziflam to at least one additional herbicide may be 25:1 to 1:25, 1:10 to 10:1, or 5:1 to 1:5.

Indaziflam treatments according to the invention provide better residual downy brome control 2 and 3 year-after-treatment (YAT) as compared to imazapic, glyphosate, and rimsulfuron. In addition, although indaziflam has been restricted to sites not grazed by domestic livestock, there appears to have no meat or milk toxicity issues. This suggests the potential of using indaziflam for pre-emergence control of weeds in graze land.

Herbicidal compositions containing indaziflam may be used to control pests, such as annual grasses and broadleaf weeds. Indaziflam works well against, for example, crabgrass, goosegrass, kyllinga, bluegrass, doveweed, swinecress, bittercress, and henbit.

The composition containing a cellulose biosynthesis inhibitor, e.g., indaziflam, can be formulated in any desired manner and include any desired excipients. The compositions can be formulated as a foliar composition, a foliar spray, solutions, emulsions, suspension, coating formulation, encapsulated formulation, solid, liquid, fertilizer, paste, granule, powder, suspension, or suspension concentrate. The composition may be employed alone or in solid, dispersant, or liquid formulation. In yet another aspect, a composition described herein is formulated as a tank-mix product.

These compositions may be produced in any desired or known manner, for example, by mixing the active compounds with extenders, such as liquid solvents, pressurized liquefied gases and/or solid carriers, optionally with the use of surface-active agents, such as emulsifiers and/or dispersants and/or foam formers. If the extender used is water, it is also useful to employ for example organic solvents as cosolvents. Suitable liquid solvents include: aromatics, such as xylene, toluene or alkylnaphthalenes, chlorinated aromatics or chlorinated aliphatic hydrocarbons, such as chlorobenzenes, chloro-ethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers include those liquids which are gaseous at ambient temperature and at atmospheric pressure, for example aerosol propellants, such as halogenated hydrocarbons and also butane, propane, nitrogen and carbon dioxide. As solid carriers, there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules, there are suitable: for example, crushed and fractionated natural rocks, such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

Compositions described herein can be applied to a soil, plant, crop, seed, leaf, or plant part thereof in a single application step. In another aspect, compositions described herein may be applied to a plant, crop, seed, leaf, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

Compositions described herein can be applied to a soil, plant, crop, seed, or plant part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 45 days, about 50 days, or about 56 days.

Compositions described herein can be applied to a plant, crop, seed, or plant part thereof to be controlled, for example to control wildfires, one or more times during a growing season. In another aspect, compounds or compositions described herein may be applied to a plant, crop, seed, or plant part thereof in one, two, three, four, or five or more times during a growing season. In another aspect, compounds or compositions described herein may be applied to a plant, crop, seed, or plant part thereof only one time, no more than two times, or no more than three times during a growing season. In yet another aspect, compounds or compositions may be applied in a single step to a seed.

Compounds or compositions described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

Compositions disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematacide, a nutritional or horticultural supplement, or any combination thereof. In an aspect, a composition described herein is odor free.

In another aspect, the disclosure provides for pre-plant, pre-emergent, post-emergent, application steps or combinations thereof. In another aspect, compounds or compositions described herein may be first applied in a pre-plant step and followed by one or more pre-emergent or post-emergent steps. In yet another aspect, the disclosure provides for only a pre-plant step.

### Examples

Because indaziflam is a root inhibiting herbicide, this allows for increased safety on desirable perennial plants that have roots below the layer where the herbicide is active. Indaziflam has excellent pre-emergence activity on many grass and broadleaf weeds and has several attributes that have been found to make it an ideal candidate to control weeds that reproduce primarily by seed production, 1) long soil-residual activity and 2) no injury to perennial grasses, forbs, and shrubs.

The present inventors found that indaziflam has several attributes that could be used to enhance invasive plant management. For example, the present inventors conducted a field study to determine if tank-mix treatments combined with indaziflam could provide longer residual Dalmatian toadflax and downy brome control than aminocyclopyrachlor, imazapic, and picloram applied alone. Results show that indaziflam applied alone could increase residual downy brome control. In addition, the present inventors conducted a greenhouse bioassay to compare the pre-emergence control of nine additional weeds found on rangeland and other non-crop areas with aminocyclopyrachlor, aminopyralid, and indaziflam, which all have relatively low recommended field use rates.

Field Experiments

Materials and Methods

Herbicide Efficacy Field Trial and Experimental Design

The present inventors conducted a field trial to evaluate the effectiveness of herbicides for long-term downy brome and Dalmatian toadflax control. The experiment was conducted at one site. The results provide the framework for the subsequent greenhouse experiment. (See below). The field experiment was located in Longmont, Colo. (lat 40° 14′57.53″N, long 105° 12′35.46″W) on Rabbit Mountain Open Space, the easternmost point of the foothills in Boulder County. The canopy cover of actively growing downy brome and Dalmatian toadflax at peak standing crop was approximately 85% and 30%, respectively. Before herbicide application (June and August), perennial grasses (<10% canopy cover) included primarily western wheatgrass (Pascopyrum smithii (Rydb.) A. Love), and native forbs and sub-shrubs (˜20% canopy cover) included Louisiana sage (Artemisia ludoviciana Nutt.), fringed sage (Artemisia frigida Willd.), common sunflower (Helianthus annuus L.), sulphur-flower buckwheat (Eriogonum umbellatum Torr.), and hairy goldenaster (Heterotheca villosa (Pursh) Shinners). The soil at the study site was Baller sandy loam (loamy-skeletal, mixed, superactive, mesic Lithic Haplustolls), with 1.5% organic matter in the top 20 cm. The average elevation was 1,725 m (5,660 ft). Mean annual precipitation based on the 30-yr average was 363 mm and the mean annual temperature was 9.1° C. Precipitation was close to the 30-yr average. A statewide-drought occurred and average total precipitation decreased 134 mm; however, the site received an additional 110 mm above the 30-yr average.

TABLE 1
Herbicides and rates applied in evaluating the dose-response of eight annual, biennial, and perennial weed species.

| | | Rates applied^{a} | Application | |
|---|---|---|---|---|
| Common name | Trade name | (g ai ha⁻¹) | timing^{b} | Manufacturer |
| Aminocyclopyrachlor | Method | 57 | June | Bayer CropScience; Research Triangle Park, NC |
| Imazapic | Plateau | 105 | June | BASF Specialty Products; Research Triangle Park, NC |
| Picloram | Tordon | 227 | June | Dow AgroSciences, LLC; Indianapolis, IN |
| Aminocyclopyrachlor + | Method + | 57 + 58 | June | Bayer CropScience; Research Triangle Park, NC |
| Indaziflam | Esplanade | | | |
| Picloram + | Tordon + | 227 + 58 | June | Dow AgroSciences, LLC; Indianapolis, IN |
| Indaziflam | Esplanade | | | Bayer CropScience; Research Triangle Park, NC |
| Aminocyclopyrachlor | Method | 57 | August | Bayer CropScience; Research Triangle Park, NC |
| Imazapic | Plateau | 105 | August | BASF Specialty Products; Research Triangle Park, NC |
| Picloram | Tordon | 227 | August | Dow AgroSciences, LLC; Indianapolis, IN |
| Aminocyclopyrachlor + | Method + | 57 + 58 | August | Bayer CropScience; Research Triangle Park, NC |
| Indaziflam | Esplanade | | | |
| Picloram + | Tordon + | 227 + 58 | August | Dow AgroSciences, LLC; Indianapolis, IN |
| Indaziflam | Esplanade | | | Bayer CropScience; Research Triangle Park, NC |
| Aminocyclopyrachlor + | Method + | 57 + 105 | August | Bayer CropScience; Research Triangle Park, NC |
| Imazapic | Plateau | | | BASF Specialty Products; Research Triangle Park, NC |
| Picloram + | Tordon + | 227 + 105 | August | Dow AgroSciences, LLC; Indianapolis, IN |
| Imazapic | Plateau | | | BASF Specialty Products; Research Triangle Park, NC |

^{a}All treatments included 1% v v⁻¹ methylated seed oil.
^{b}At the June and August application timings, Dalmatian toadflax was in the flowering and re-growth stages, respectively, while both application timings were pre-emergence for downy brome.

Herbicides were applied in the summer at two application timings; June, when Dalmatian toadflax was in the flowering growth stage, and August, during Dalmatian toadflax regrowth. These two application timings (June and August) were both before downy brome emergence (PRE). The 13 herbicide treatments (including a non-treated control) were applied to 3 by 9 m plots arranged in a randomized complete block design with four replications, and are listed in Table 1. All treatments were applied with a CO₂-pressurized backpack sprayer using 11002LP flat fan nozzles at 187 L·ha⁻¹ at 207 kPa. All treatments included 1% v·v⁻¹ methylated seed oil.

Visual percent control evaluations were conducted in June of each year (1 YAT-4 YAT). Control evaluations were estimated by comparing visual estimates of Dalmatian toadflax and downy brome cover in the treated plots (using the entire 3 by 9 m plot area) compared with the non-treated plots. Plots with 0% canopy cover received a 100% control rating, while conversely, plots with 100% canopy cover received a 0% control rating.

Data Analysis

For the herbicide efficacy field experiment, repeated measures analysis of variance (ANOVA) was used to determine the effects of herbicide treatments on long-term Dalmatian toadflax and downy brome control. Percent control data were first analyzed in SAS 9.3 using Proc MIXED, with year after treatment defined as the repeated measure (SAS Institute 2010). A Tukey-Kramer adjustment was performed and factors included in the model were treatment, timing, year, and all possible interactions. Dalmatian toadflax and downy brome control response variables were analyzed separately, and main effects and interactions were tested at the α=0.05 significance level. Before analysis, all response variables were arcsine square root-transformed to meet the assumption of normality. To determine herbicide impacts on residual Dalmatian toadflax and downy brome control, the significant treatment-by-year interaction was evaluated using the Proc GLIMMIX method and the LINES statement. This provides comparisons of least squares means across years (P≤0.05). Non-transformed means are presented in all figures.

Results and Discussion

Dalmatian Toadflax Control

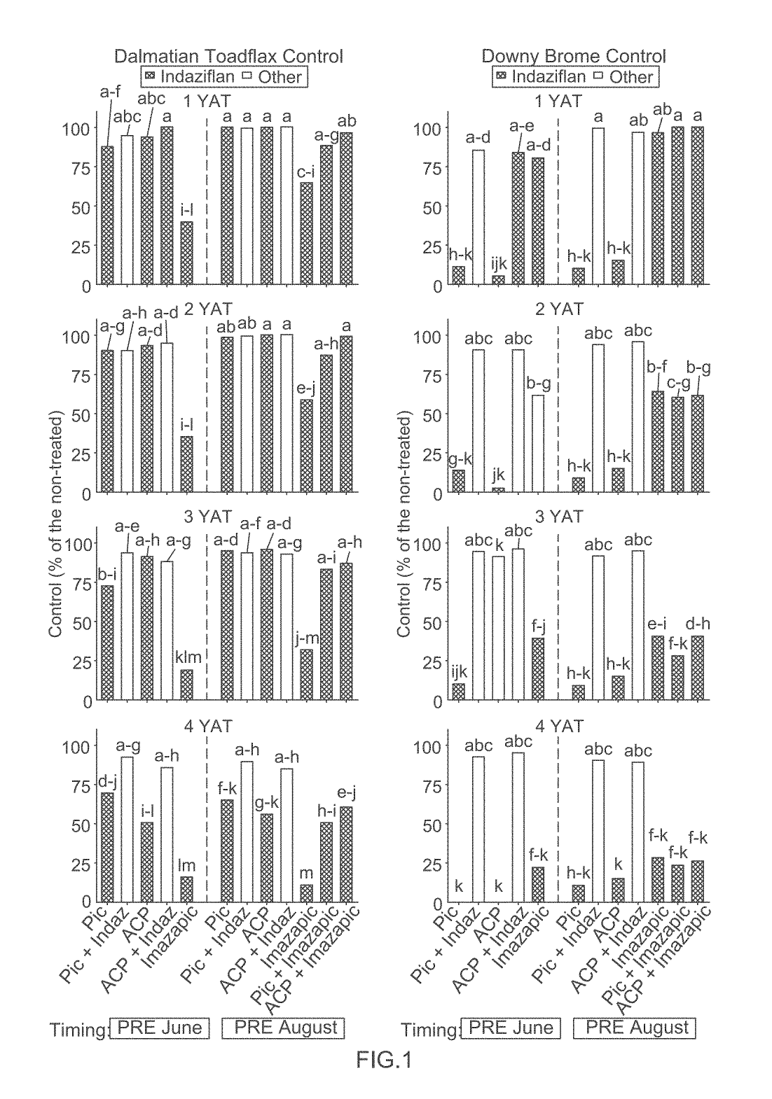

FIG. 1 (left panels) show, at both application timings (June and August), the significant treatment-by-year interaction (P<0.001). All herbicide treatments, except imazapic, provided similar Dalmatian toadflax control 1, 2, and 3 YAT. The only treatments providing residual Dalmatian toadflax control above 80% 4 YAT were treatments including indaziflam, i.e., indaziflam (Indaz)+picloram (Pic) and indaziflam (Indaz)+aminocyclopyrachlor (ACP).

FIG. 1 (left panels) also shows, at the June and August application timings, aminocyclopyrachlor (ACP) alone provided 50% and 55% Dalmatian toadflax control, while control with picloram (Pic) was 68% and 64% 4 YAT, respectively. These same treatments tank-mixed with indaziflam resulted in 84 to 91% Dalmatian toadflax control 4 YAT. In contrast, while Dalmatian toadflax control with aminocyclopyrachlor (ACP) was 90 to 97% 1 YAT, seedlings, however, appeared in plots as early as 15 month-after-treatment (MAT), and there was limited control of those individuals (4 to 26%) 2 YAT. These results show the importance of residual weed seedling control following the initial year of application because, without residual weed seedling control, invasive weeds, such as Dalmatian toadflax, are able to re-establish via the soil seed bank.

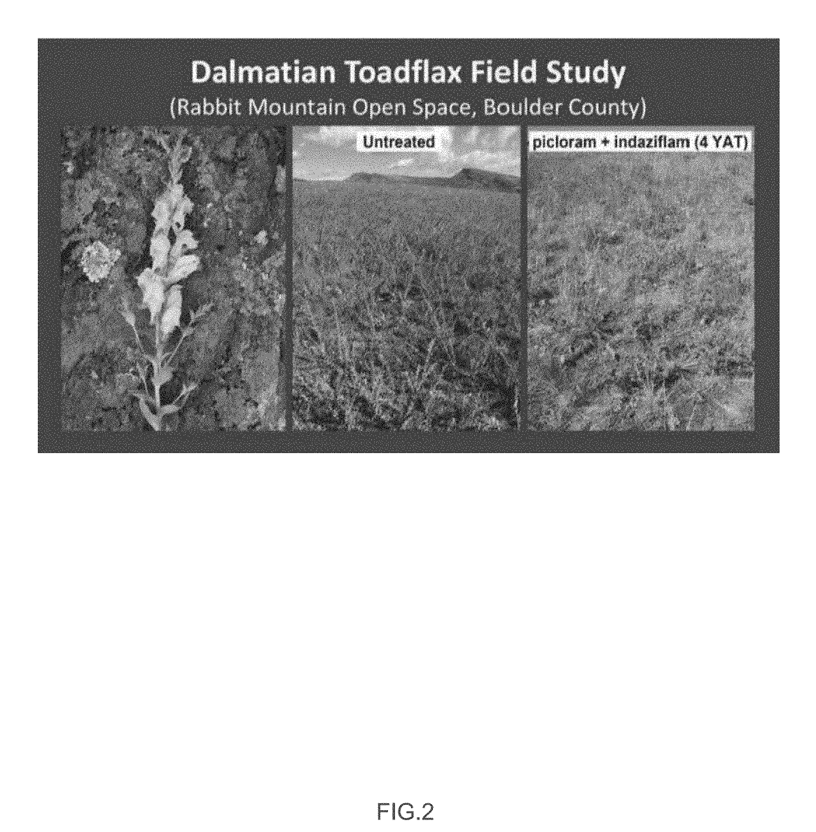

FIG. 2 shows improved residual Dalmatian toadflax control 4 YAT (right panel) using indaziflam and picloram as compared with that of the untreated (middle panel).

Downy Brome Control.

FIG. 1 (right panels) shows the treatment-by-year interaction (P<0.001) was more pronounced for downy brome than with Dalmatian toadflax, and there was no effect of application timing on herbicide efficacy (P=0.830). Comparing to the non-treated plots, downy brome control with imazapic and indaziflam treatments were statistically similar at P<0.05 (84 to 99%) 1 YAT. However, residual downy brome control was greatly reduced for imazapic alone 2 YAT (61 to 64%). By 4 YAT, the downy brome population had recovered via the soil seed bank and imazapic control was less than 25%. Indaziflam treatments, however, provided significantly greater residual downy brome control 3 YAT (91 to 96%) and 4 YAT (89 to 94%), as compared with that of treatments without indaziflam.

Indaziflam's soil residual properties combined with the results from this and other similar field experiments provide evidence that indaziflam used alone or in combination with commonly recommended broadleaf herbicides (e.g. aminocyclopyrachlor and picloram), could significantly decrease the soil seed bank of annual and biennial species, such as downy brome and Dalmatian toadflax. This could greatly decrease weed seedling pressure in the years following initial treatments, providing the time necessary to facilitate the recovery of co-occurring species. By reducing yearly applications to potentially every 4 years, as these data suggest, this would decrease herbicide costs, reduce the total amount of herbicide applied, minimize non-target impacts, and reduce the potential of artificially shifting the native plant community with annual herbicide treatments.

Greenhouse Experiments

Materials and Methods

Comparing Aminocyclopyrachlor, Aminopyralid, and Indaziflam Pre-Emergence Weed Control

Result from this field experiments establishes that indaziflam's control of germinating seeds provided residual Dalmatian toadflax and downy brome control 4 YAT. Based on these data, it is possible that indaziflam may also provide residual control of many other invasive weeds found in non-crop areas. Thus, these field experiments were then used as a foundation for the subsequent greenhouse bioassay to compare the pre-emergence control of aminocyclopyrachlor, aminopyralid, and indaziflam.

A greenhouse experiment was designed to determine if the extended control of Dalmatian toadflax and downy brome provided by indaziflam in the field was due to increased residual seedling control. This experiment was designed to compare indaziflam's pre-emergence efficacy to the currently recommended herbicides (aminocyclopyrachlor and aminopyralid) for annual, biennial, and perennial weed control in non-crop areas. Aminopyralid was used in this greenhouse bioassay in place of picloram because the average recommended use rate for indaziflam is comparable to the average aminopyralid use rate. This allows for direct comparisons between herbicides on an active ingredient basis for aminopyralid, aminocyclopyrachlor, and indaziflam.

For the greenhouse bioassay, seeds were planted at a constant depth of 0.5 cm in 13- by 9- by 6-cm plastic containers, filled with an Otero sandy clay loam field soil (Coarse-loamy, mixed (calcareous), mesic Aridic Ustorthents) with 3.9% OM and pH 7.7. Seeding densities were adjusted based on germinability to reach a target density of 40 plants/pot. Plants were maintained in a greenhouse with a 25/20° C. day/night temperature with natural light supplemented with high-intensity discharge lamps to give a 15-h photoperiod. Plants were sub-irrigated as needed and misted overhead daily to reduce soil crusting.

TABLE 2
Species, herbicides, and rates applied in greenhouse studies evaluating the dose-response of nine annual,
biennial, and perennial weed species.

| | | Rates applied (g ai ha⁻¹) | | |
|---|---|---|---|---|
| Common name | Scientific name | Aminocyclopyrachlor | Aminopyralid | Indaziflam |
| Common mullein | Verbascum thapsus | 0, 9, 18, 35, 70, 140, 210, 280 | 0, 1.8, 3.5, 7, 14, 28, 56, 112 | 0, 0.2, 0.4, 0.7, 1.5, 2.9, 5.9, 11.7 |
| Common teasel | Dipsacus fullonum | 0, 1, 2, 4, 9, 18, 35, 70 | 0, 0.9, 1.8, 3.5, 7, 14, 28, 56 | 0, 0.2, 0.4, 0.7, 1.5, 2.9, 5.9, 11.7 |
| Curly dock | Rumex crispus | 0, 2, 4, 9, 18, 35, 70, 140 | 0, 0.9, 1.8, 3.5, 7, 14, 28, 56 | 0, 0.2, 0.4, 0.7, 1.5, 2.9, 5.9, 11.7 |
| Dalmatian | Linaria dalmatica | 0, 1, 2, 4, 9, 18, 35, 70 | 0, 1.8, 3.5, 7, 14, 28, 56, 112 | 0, 0.05, 0.1, 0.2, 0.4, 0.7, 1.5, 2.9 |
| toadflax | | | | |
| Diffuse | Centaurea diffusa | 0, 4, 9, 18, 35, 70, 140, 280 | 0, 1.8, 3.5, 7, 14, 28, 56, 112 | 0, 0.2, 0.4, 0.7, 1.5, 2.9, 5.9, 11.7 |
| knapweed | | | | |
| Downy brome | Bromus tectorum | 0, 9, 18, 35, 70, 140, 280, 560 | 0, 3.5, 7, 14, 28, 56, 112, 224 | 0, 0.2, 0.4, 0.7, 1.5, 2.9, 5.9, 11.7 |
| Halogeton | Halogeton | 0, 2, 4, 9, 18, 35, 70, 140 | 0, 0.9, 1.8, 3.5, 7, 14, 28, 56 | 0, 0.1, 0.2, 0.4, 0.7, 1.5, 2.9, 5.9 |
| | glomeratus | | | |
| Marestail | Conyza Canadensis | 0, 0.5, 1, 2, 4, 9, 18, 35 | 0, 0.9, 1.8, 3.5, 7, 14, 28, 56 | 0, 0.1, 0.2, 0.4, 0.7, 1.5, 2.9, 5.9 |
| Musk thistle | Carduus nutans | 0, 1, 2, 4, 9, 18, 35, 70 | 0, 0.9, 1.8, 3.5, 7, 14, 28, 56 | 0, 0.2, 0.4, 0.7, 1.5, 2.9, 5.9, 11.7 |

^{a}All treatments were applied pre-emergence.

The greenhouse experiment was a completely randomized design with a factorial of seven herbicide rates and a non-treated control with three replicates per treatment. The experiments were conducted at two different times. A preliminary greenhouse study was conducted for each herbicide and species to determine a range of doses that would best fit a logistic regression. It is not unusual for both pre-emergence and post-emergence herbicides to provide control at lower than labeled rates, e.g., 0.5-560 g ai ha⁻¹ (aminocyclopyrachlor), 0.9-224 g ai ha⁻¹ (aminopyralid), and 0.05-11.7 g ai ha⁻¹ (indaziflam) in the greenhouse with ideal environmental conditions, so it was not surprising that herbicide doses for the regression analysis were much lower than recommended field use rates. Rates used in the dose-response are listed in Table 2. Herbicides were applied pre-emergence using a Generation III research track sprayer (DeVries Manufacturing, Hollandale, Minn.) equipped with a TeeJet 8002 EVS flat-fan spray nozzle (TeeJet Spraying Systems Co., Wheaton, Ill.) at 187 L·ha-1 at 172 kPa.

Plants were harvested at the soil surface approximately 4 to 5 week-after-treatment (WAT) depending on the growth stage of each species. Weights were recorded after samples were dried for 5 days at 60° C. Percent dry weight reduction was calculated relative to the non-treated control plants for each treatment.

Data Analysis

Data from the greenhouse dose-response experiment were first analyzed using the PROC MIXED method in SAS 9.3 with treatment as a fixed effect and experiment and replicate as random effects (SAS Institute 2010). Based on a non-significant homogeneity of variance (ANOVA) and experiment-by-herbicide rate interaction, results from the repeated experiments were pooled. The treatment effect was significant, therefore, nonlinear regression in Graphpad Prism 7.00 (GraphPad Software, La Jolla Calif. USA) was used to describe the response of the nine weed species to aminocyclopyrachlor, aminopyralid, and indaziflam. The herbicide concentrations resulting in 50% reduction in plant biomass (GR₅₀) compared to the non-treated control were determined for each invasive weed species using four-parameter log-logistic regression. The equation used to regress herbicide concentration with percent reduction in plant dry biomass as compared to the non-treated control was:

$$Y = C + [ \frac{( D * C )}{1 + {10}^{( Log {GR}_{50} - X ) \cdot b}} ] \qquad [ 1 ]$$

where C and D represent the lower and upper limits of the dose-response curve, respectively, and b represents the slope of the best-fitting curve through the GR₅₀ value. For curve fitting and GR₅₀ estimation, the model was constrained to a maximum of 100 and minimum of 0. Mean separation of herbicide GR₅₀ values were analyzed by Fisher's Protected LSD test at the 5% level of probability. The average recommended use rate for indaziflam ranges from 83 to 94% (73 and 102 g ai ha⁻¹) of the average recommended aminocyclopyrachlor (70 to 140 g ae ha⁻¹) and aminopyralid (53 to 123 g·ae·ha⁻¹). Therefore, pre-emergence control was compared directly using GR₅₀-estimates.

Results and Discussion

TABLE 3
Aminocyclopyrachlor, aminopyralid, and indaziflam rates resulting in 50 percent growth reduction of
nine common invasive weeds found on non-cropland. Values were calculated using log-logistic regression^{b}

| | GR₅₀^{a} (g ai ha⁻¹) | | | GR₅₀ ratio | |
|---|---|---|---|---|---|
| Weed | Aminocyclopyrachlor | Aminopyralid | Indaziflam | Aminocyclopyrachlor/ | Aminopyralid/ |
| (common name) | (g · ai · ha⁻¹) | (g · ai · ha⁻¹) | (g · ai · ha⁻¹) | Indaziflam | Indaziflam |
| Common mullein | 3.05 b | 7.45 c | 0.07 a | 44.57 | 106.43 |
| Common teasel | 6.89 c | 0.75 a | 1.33 b | 5.18 | 0.56 |
| Curly dock | 21.3 b | 1.25 a | 1.10 a | 19.36 | 1.14 |
| Dalmatian toadflax | 1.16 b | 14.8 c | 0.06 a | 19.33 | 246.67 |
| Diffuse knapweed | 6.20 c | 2.50 b | 0.58 a | 10.69 | 4.31 |
| Downy brome | 56.4 b | 38.5 b | 0.39 a | 144.62 | 98.72 |
| Halogeton | 1.04 b | 3.11 c | 0.36 a | 2.89 | 8.64 |
| Marestail | 2.09 c | 0.80 b | 0.17 a | 12.29 | 4.71 |
| Musk thistle | 1.25 b | 0.31 a | 0.33 a | 3.79 | 0.94 |

^{a}Herbicide dose resulting in 50% dry biomass reduction.
^{b}GR₅₀ values within each weed (row) followed by the same lower case letter are not significantly different at the 5% level of probability.

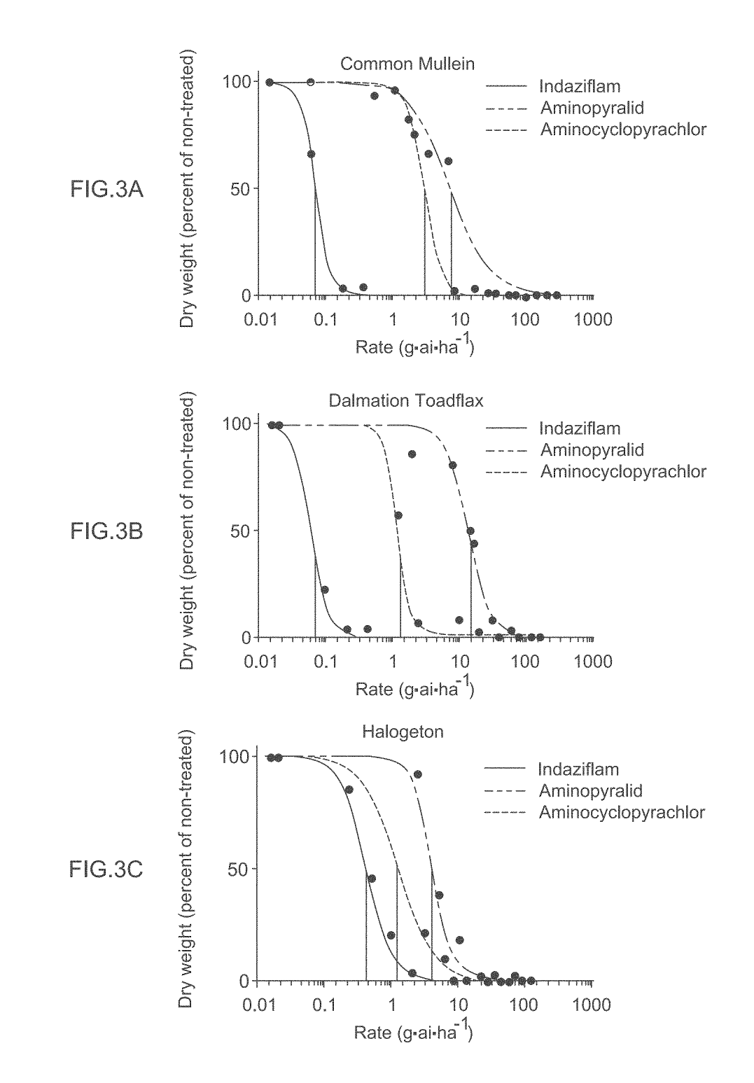

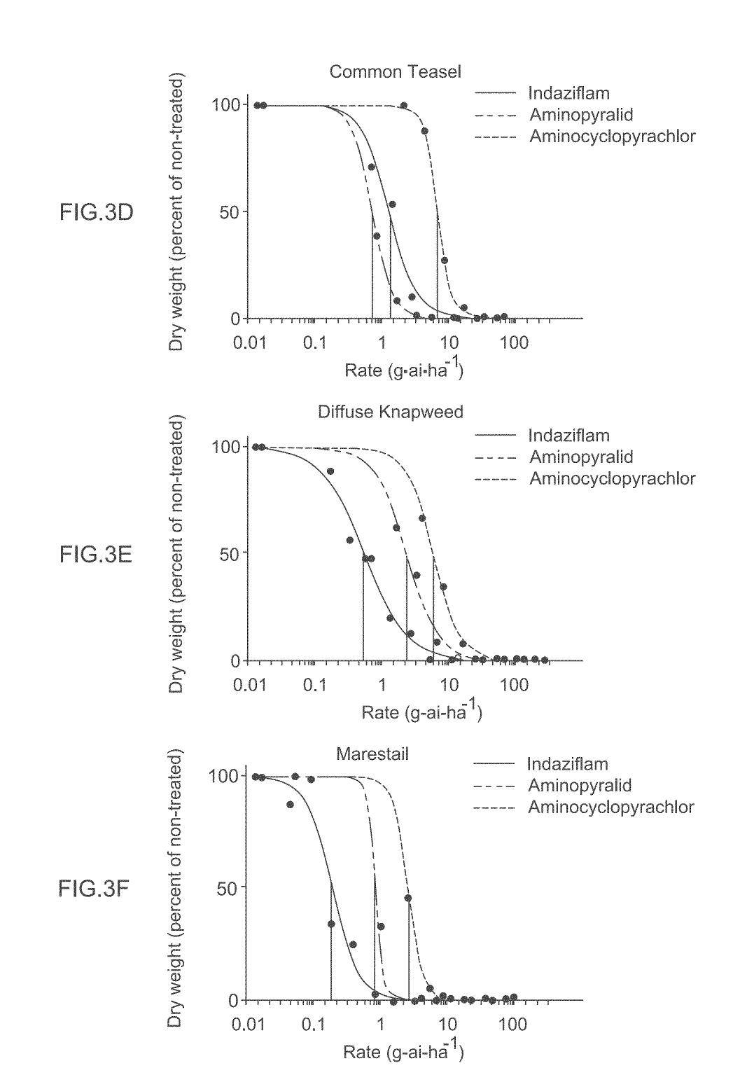

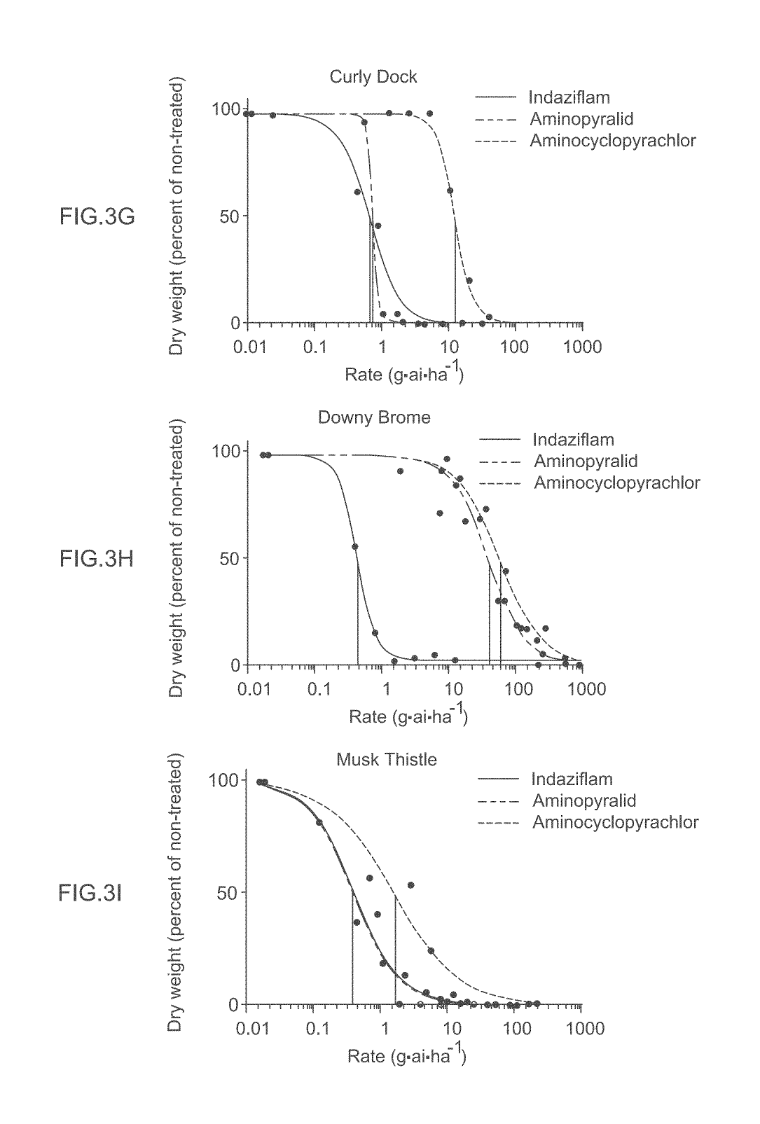

FIGS. 3B and 3H, respectively, show Dalmatian toadflax and downy brome control with aminocyclopyrachlor, aminopyralid, and indaziflam. GR₅₀ estimates for downy brome (FIG. 3H) show that indaziflam was 125- and 99-times more active compared to aminocyclopyrachlor and aminopyralid, respectively (P<0.0001, Table 3). Similarly, indaziflam was 19- and 247-times more active on Dalmatian toadflax pre-emergence (FIG. 3B) compared to aminocyclopyrachlor and aminopyralid, respectively (P<0.0001, Table 3). These results suggest that indaziflam-mediated control of germinating seeds may be the cause of extended weed control with indaziflam under field conditions for Dalmatian toadflax and downy brome as compared with treatments without indaziflam, as shown in FIG. 1.

FIGS. 3A, 3C-3G, and 3I also show responses of seven other weed species to aminocyclopyrachlor, aminopyralid, and indaziflam. GR₅₀ estimates are shown in Table 3. Indaziflam was 106- (P<0.0001), 4- (P<0.0001), 9- (P=0.0012), and 5-times (P<0.0001) more active than aminopyralid on common mullein (FIG. 3A), diffuse knapweed (FIG. 3E), halogeton (FIG. 3C), and marestail (FIG. 3F), respectively. However, indaziflam and aminopyralid have similar activity on curly dock (P=0.3421) (FIG. 3G) and musk thistle (P=0.8674) (FIG. 3I) (Table 3). Aminopyralid was 2- and 9-times more active (lower GR₅₀) on common teasel (FIG. 3D) compared to indaziflam and aminocyclopyrachlor, respectively (P<0.0001) (Table 3). Compared to aminocyclopyrachlor across all nine weed species, indaziflam was 3- to 145-times more active (P<0.0001, Table 3). Averaging across all nine weed species, indaziflam was 29- and 52-times more active then aminocyclopyrachlor and aminopyralid, respectively. This result indicates that indaziflam appears to provide increased seedling control of these invasive species as compared to commonly recommended broadleaf herbicides. These data are consistent with the idea that the long-term residual control by indaziflam observed in the field, as shown in FIG. 1, could be due to less dilution in the soil profile and increased relative potency as compared to other broadleaf herbicides, such as aminocyclopyrachlor and aminopyralid.

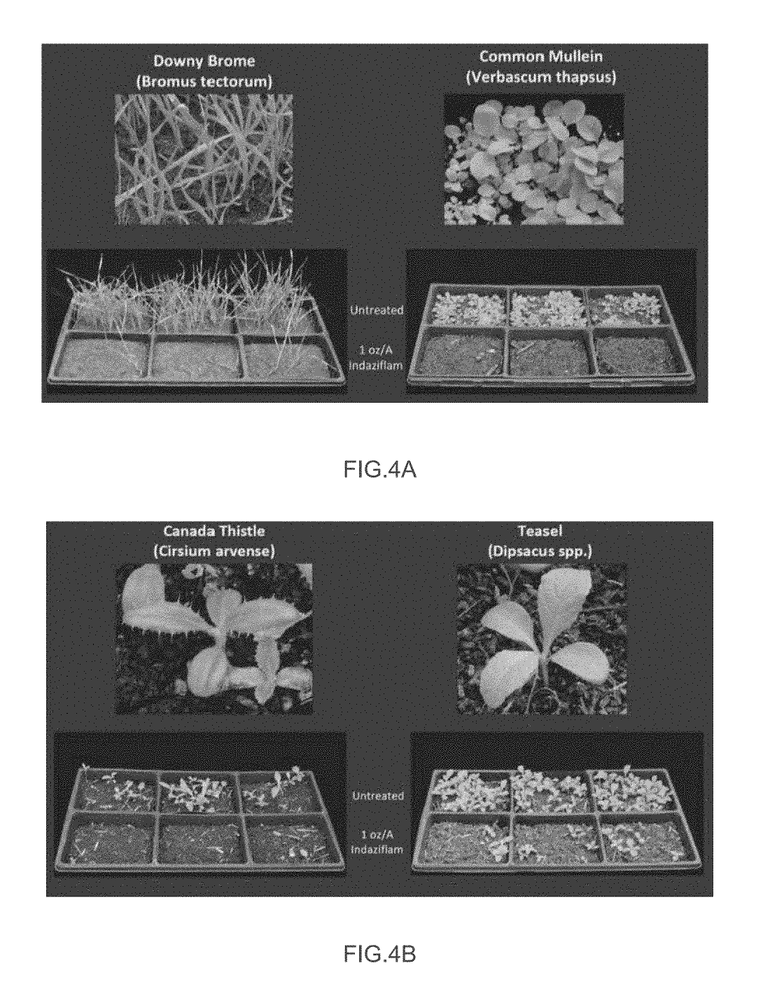

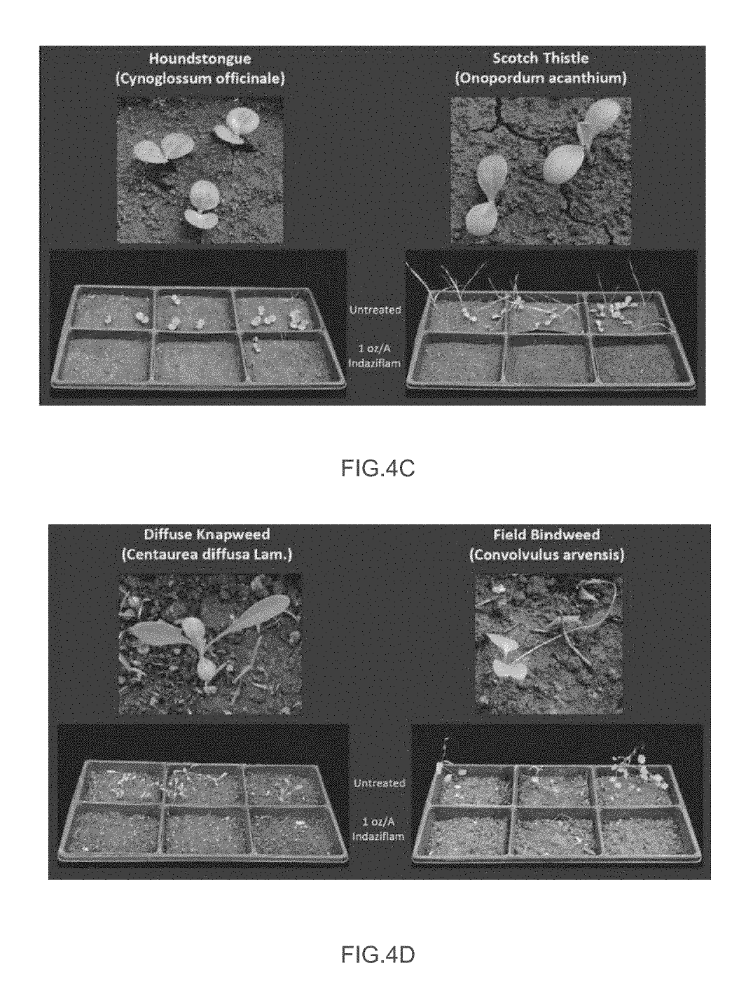

Consistently, FIG. 4A-4D show, as compared with the untreated, indaziflam treatment improved seedling control of invasive weeds, such as downy brome (Bromus tectorum) (FIG. 4A, left panel), common mullein (Verbascum thapsus) (FIG. 4A, right panel), Canada thistle (Cirsium arvense) (FIG. 4B, left panel), teasel (Dipsacus spp.) (FIG. 4B, right panel), houndstongue (Cynoglossum officinale) (FIG. 4C, left panel), Scotch thistle (Onopordum acanthium) (FIG. 4C, right panel), diffuse knapweed (Centaurea diffusa Lam.) (FIG. 4D, left panel), and field bindweed (Convolvulus arvensis) (FIG. 4D, right panel).

Because indaziflam has limited post-emergence activity, tank-mixing with other herbicides may be needed to control established weeds. For example, indaziflam could be tank-mixed with other herbicides commonly used for non-crop weed management, e.g., 2,4-D, chlorsulfuron, clopyralid, dicamba, glyphosate, imazapyr, metsulfuron, and triclopyr. Such a tank-mix could extend weed control beyond the initial year of application and provide multiple modes of action in a single application as a tool for resistance management. Indaziflam could also provide residual activity necessary to control germinating seedlings that appear as early as the year after initial herbicide application.

Tank-mixing indaziflam with the suite of primarily broadleaf herbicides provides land managers with an opportunity to consider managing the soil seed bank of invasive weeds in non-crop areas. This may provide the necessary time for co-occurring species to respond with increased abundance, increasing overall resistance and resilience of the dominant native plant community. Thus, integrating indaziflam into other mechanical, cultural, and biological tools could greatly increase the success of long-term management programs.

Wildfire Control

As described above, indaziflam can control several winter annual grasses and annual and biennial broadleaf weeds even in high residue situations. Greenhouse studies show that indaziflam is highly effective in controlling winter annual grasses at very low rates. Under field conditions, indaziflam residual control can extend for four growing seasons. These results raise the possibility that indaziflam may bind to plant residue on the soil surface (often referred to as thatch) with relatively high affinity as compared with other commonly used herbicides. Indeed, indaziflam has low water solubility and, thus, a high percentage of intercepted herbicide could be irreversibly bound to thatch compared to imazapic. In addition, in some rangeland and natural area settings, a prescribed fire or a low intensity wildfire would be considered a restorative event and might provide an ideal situation to evaluate the impact of plant residue on indaziflam's performance.

Downy brome thatch can be up to 15 cm thick in areas that have not recently burned. Indaziflam controls downy brome under a variety of field conditions for 3 to 4 years and under greenhouse conditions. Indaziflam may also control other winter annual grass invaders, like medusahead (Taeniatherum caput-medusae) and ventenata (Ventenata dubia). One characteristic of these winter annual grass infestations is that large quantities of thatch accumulate on the soil surface over time. These winter annual grasses may produce and set seed, senescing early in the season before many native species come out of winter dormancy. This may leave thick layers of thatch, which may not only prevent herbicides from penetrating and reaching the soil, but also increase the risk of wildfire. Therefore, reducing winter annual grasses thatch layers may decrease wildfire risk.

Long-Term Control of Invasive Winter Annual Grasses

The present inventors have found that indaziflam can provide long-term selective control of the most prevalent invasive winter annual grass, i.e., downy brome (Bromus tectorum L.) in the U.S. Downy brome is highly resistant to acetolactate synthase (ALS) (imazamox, primisulfuron, propoxycarbazone, sulfosulfuron) and photosystem II inhibitors (PSII) (atrazine, metribuzin), and moderately resistant to acetyl CoA carboxylase inhibitors (ACCase) (clethodim, fluazifop). Imazapic and glyphosate are two most commonly recommended herbicides for invasive winter annual grass control. These herbicides, however, provide inconsistent control or injury to desirable perennial species, and represent two modes of action that are prone to resistance development.

Indaziflam has a unique mode of action compared to other CBI herbicides because it can control both monocots and dicots. The present inventors found that indaziflam can control other monocot weeds including feral rye, Japanese brome (Bromus japonicus Thunb. or Bromus arvensis L.), jointed goatgrass (Aegilops cylindrica L.), medusahead (Taeniatherum caput-medusae [L.] Nevski), and ventenata (Ventenata dubia (Leers) Coss).

Invasive Winter Annual Grass Field Efficacy Studies

Site Description

In year 1, field experiments were conducted to compare the effectiveness of indaziflam and imazapic for long-term invasive winter annual grass control, and to evaluate the response of the native plant communities. The experiments were established at two sites on the Colorado Front Range dominated by invasive winter annual grasses. Site 1 (lat 40° 15′2″N, long 105° 12′56″W) was infested with equal amounts of downy brome and Japanese brome. Site 2 (lat 40° 43′23″N, long 104° 55′58″W) was infested with feral rye. These two sites were approximately 58 km apart. Site 1 was located on Rabbit Mountain Open Space (Boulder County). Site 2 was located on a Colorado Parks and Wildlife Area (Larimer County). Before herbicide application in July, visual estimates were made across the entire study area of percentage of living canopy cover for all species present at both sites.

TABLE 4
List of co-occurring species at Site 1.

| Common Name | Scientific Name |
|---|---|
| Blue grama | Bouteloua gracilis (Willd. ex Kunth) Lag. |
| | Ex Griffiths |
| Western wheatgrass | Pascopyrum smithii (Rydb.) A. Love |
| Western ragweed | Ambrosia psilostachya DC. |
| Tarragon | Artemisia dracunculus L. |
| Fringed sagebrush | Artemisia frigida Willd. |
| Prairie sage | Artemisia ludoviciana Nutt. |
| Winged buckwheat | Eriogonum alatum Torr. |
| Blanketflower | Gaillardia aristata Pursh |
| Parry's geranium | Geranium caespitosum James var. |
| | parryi (Engelm.) W. A. Weber |
| Dotted gayfeather | Liatris punctata Hook. |
| Pricklypear cactus | Opuntia polyacantha Haw. |
| Slender-flowered | Psoralidium tenuiflorum (Pursh) Rydb. |
| scurfpea | |
| Prairie coneflower | Ratibida columnifera (Nutt.) Wooton & Standl. |
| Woods' rose | Rosa woodsii Lindl. |
| Scarlet globemallow | Sphaeralcea coccinea (Nutt.) Rydb. |
| Porter's aster | Symphyofrichum porteri (A. Gray) G. L. Nesom |
| Yellow salsify | Tragopogon dubius Scop. |

Site 1 was characterized by ˜80-100% downy brome and Japanese brome canopy cover with a dense fine-fuel layer, e.g., thatch, (2 to 5 cm), and a scattered stand of co-occurring species (˜0-10% canopy cover, Table 4). Site 2 had >95% canopy cover of actively growing feral rye, a fine fuel layer of 2 to 5 cm, and <5% canopy cover of western wheatgrass (Pascopyrum smithii (Rydb.) A. Love) and sand dropseed (Sporobolus cryptandrus (Torr.) A. Gray).

The soil at Site 1 was Baller sandy loam (loamy-skeletal, mixed, mesic Lithic Haplustolls), with 1.5% organic matter in the top 20 cm. The average elevation was 1,737 m (5,700 ft). The soil at Site 2 was Terry sandy loam (coarse-loamy, mixed, superactive, mesic Ustollic Haplargids), with 1.3% organic matter in the top 20 cm. The average elevation was 1,646 m (5,400 ft). At Sites 1 and 2, mean annual precipitation based on the 30-yr average was 379 and 363 mm, and the mean annual temperatures were 9.1 and 8.6° C., respectively. Precipitation was close to the 30-yr average in year 1. However, in year 2, both sites received an additional 199 and 212 mm above the 30-yr averages, respectively. A drought occurred in year 3 with an annual precipitation of 235 and 290 mm at Sites 1 and 2, respectively.

Experimental Design

Herbicides were applied at five application timings to evaluate variations in invasive winter annual grass control, potential non-target impacts, and the potential release of co-occurring species after herbicide treatment. Herbicides were applied both before (PRE) and after (POST) winter annual grass emergence. Timings were designated as early PRE (EPRE, July year 1), PRE (August year 1), early POST (EPOST, December year 1), POST (February year 2), and late POST (LPOST, April year 2). There were four treatments at each application timing: indaziflam (Esplanade™) at three concentrations (44, 73, and 102 g·ai·ha⁻¹) and imazapic (Plateau®) at 123 g·ai·ha⁻¹. Imazapic and indaziflam have limited to no POST activity. Therefore, all POST treatments included 420 g·ae·ha⁻¹ glyphosate (Accord® XRT II) as the burndown herbicide. The 21 herbicide treatments (including a non-treated control) were applied to 3 by 9 m plots arranged in a randomized complete block design with four replications. All treatments were applied with a CO₂-pressurized backpack sprayer using 11002LP flat fan nozzles at 187 L·ha⁻¹ at 207 kPa. All treatments included 1% v·v⁻¹ methylated seed oil.

Treatment Evaluation and Data Analysis

Biomass harvests and species richness evaluations were conducted in August (year 2 and year 3) to evaluate invasive winter annual grass control and response of co-occurring species. Above-ground biomass of the winter annual grasses, perennial grasses, and forbs were harvested from randomly placed 1-m² quadrats. Quadrats were not taken from the same location in consecutive years. Site 1 had an equal distribution of downy brome and Japanese brome. Therefore, biomass of both species was combined for analysis. Directly following harvest, the material was dried at 60° C. for 5 days to calculate dry biomass. Additionally, at Site 1, species richness was calculated for each treatment as a simple estimate of biological diversity. Species richness was defined as the total number of unique species (grasses and forbs) occurring per unit area (e.g., 27 m² plot size). These count data were assumed to follow a Poisson distribution.

Invasive winter annual grass biomass was converted to a percentage of the non-treated control. Data were combined across sites after the null hypothesis of equal variance was not rejected. However, due to unequal variances across sites for perennial grass biomass (P<0.0001), data from Sites 1 and 2 were analyzed separately. Because Site 2 only had two desirable grass species and no forbs, forb biomass data and richness are only presented for Site 1. All response variables (invasive winter annual grass biomass, perennial grass biomass, forb biomass, and species richness) were first evaluated for significant main effects and interactions by performing an ANOVA using the PROC MIXED method in SAS 9.350. Factors included in the model statement were treatment, site, year after treatment, and all interactions, with year after treatment defined as the repeated measure. The random factor was site nested within replication, and a Tukey-Kramer adjustment was performed. To meet ANOVA assumptions of normality, an arcsin square root transformation was used for invasive winter annual grass biomass (% of non-treated), a square root transformation for perennial grass and forb biomass. However, no transformations were required for forb richness. To evaluate the significant treatment-by-year interaction for all response variables (P<0.0001), an ANOVA was conducted using the PROC GLIMMIX method and the LINES statement. This provided comparisons between all pairs of least squares means across years (P<0.05). All means presented in figures are non-transformed data.

Results and Discussion

Invasive Winter Annual Grass Control

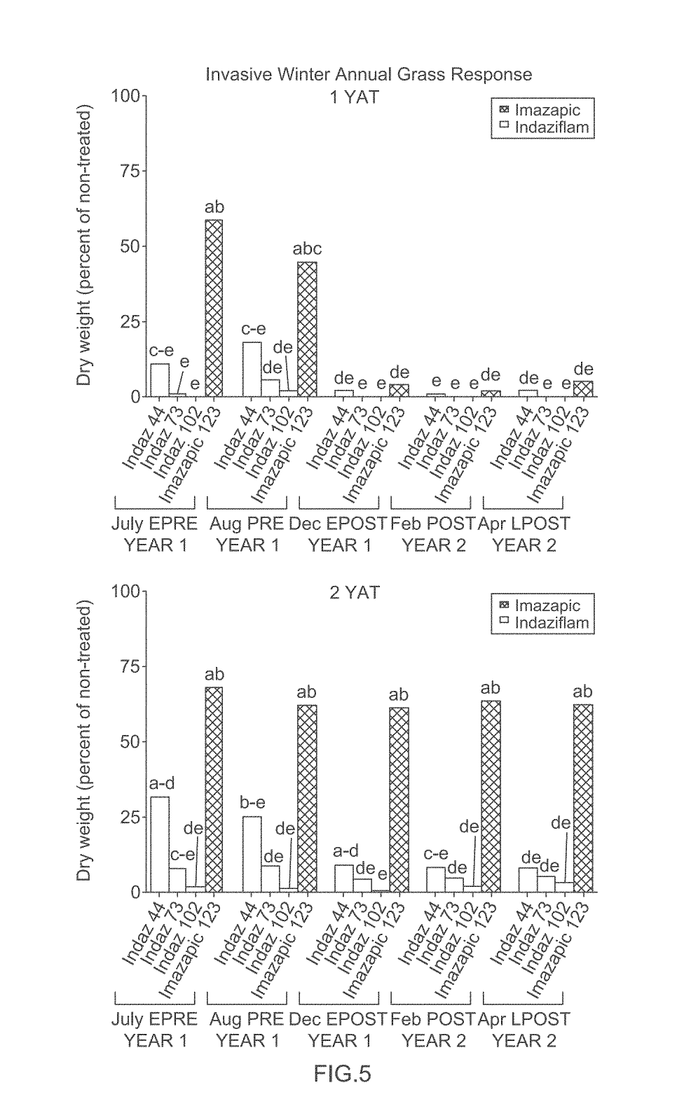

The significant treatment-by-year (P<0.0001) interaction on invasive winter annual grass control was evaluated. The combined data from Sites 1 and 2 showed a similar level of invasive winter annual grass control (downy brome, feral rye, Japanese brome) 1 year after treatment (1 YAT), except for imazapic at the EPRE timing (˜41% control, FIG. 5). Across all five application timings, indaziflam at 73 and 102 g·ai·ha⁻¹ provided >99% control 1 YAT. These data suggest that, 1 YAT, imazapic treatments at the POST timings provided superior control to imazapic applied PRE. This difference in efficacy could be explained by the addition of the glyphosate burndown at the POST timings, or the later application timings had less microbial degradation, and therefore, an increased concentration of imazapic in the soil during peak growth (summer year 2).

Indaziflam treatments across all application timings (except indaziflam applied at the lowest rate of 44 g·ai·ha⁻¹, EPRE and PRE) provided superior invasive winter annual grass control 2 YAT compared to imazapic (FIG. 5). Indaziflam applied at 102 g·ai·ha⁻¹ controlled 97 to 99%±0.5 (mean±SE) of downy brome, feral rye, and Japanese brome, while imazapic provided only 32 to 35%±1.5 control, 2 YAT (FIG. 5).

An additional observation of this study was the impact of herbicide treatments on fine fuel, e.g., thatch, accumulation. Before herbicide treatments were initiated (year 1), both sites had accumulated fine fuel layers of ˜2 to 5 cm. At both sites, indaziflam treatments eliminated further residue inputs via residual control 2 YAT, resulting in the complete decomposition of these fine fuel layers (˜9 to 12 months after treatment (MAT)).

Invasive winter annual grass control responded to indaziflam treatments in a dose-dependent manner. The 102 g·ai·ha⁻¹ concentration is highly effective and may be considered for management of invasive winter annual grasses with a short seed viability (˜3 to 5 years). To achieve or to increase the success of long-term invasive winter annual grass control, it may need to limit the seed rain during this 3- to 5-year period and choose management options that provide close to 100% control. If the soil seed bank can re-generate, the invasive winter annual grass is likely to re-establish. This may be the case for herbicides with limited soil residual activity beyond the initial year of application, such as imazapic. These data provide evidence that indaziflam can provide residual control of multiple invasive winter annual grasses that coexist at a site (FIG. 5).

The present inventors have demonstrated with field data that indaziflam can provide superior residual control of multiple invasive winter annual grasses, e.g., downy brome, feral rye, Japanese brome, as compared with the other recommended herbicide, such as imazapic. These data directly support the limited field and greenhouse studies evaluating the effectiveness of indaziflam to provide residual control of invasive winter annual grasses and other invasive biennial weeds in open spaces and natural areas.

Overall, indaziflam provided residual control 2 YAT and ultimately decreased the seed rain back into the soil seed bank. Because invasive winter annual grasses may have seed viabilities of approximately 3 to 5 years, a sequential indaziflam treatment 2 or 3 years after initial treatments may be applied to potentially exhaust the seed bank of these invasive grasses. The sequential treatments could provide the residual control necessary to reach the 3- to 5-year seed longevity period. This management approach could decrease labor and herbicide costs as compared to herbicides with limited residual control that require yearly applications (e.g., imazapic), while also minimizing the herbicide's environmental footprint.

An additional observation in this field study associated with indaziflam's long-term residual control was its utility as a tool for fine-fuels reduction. These fine fuel layers, e.g., thatch layers, associated with invasive winter annual grasses have resulted in major changes in fire-return intervals, dramatically increasing fire frequency and intensity particularly in sagebrush ecosystems of the Great Basin. Additionally, many open spaces and natural areas infested with invasive winter annual grasses are bordered by houses or other structures, and are at a high fire risk with these dense, highly flammable fine fuel layers. Fine fuel decomposition over time may be qualified with other common invasive winter annual grasses found in the US including jointed goatgrass (Aegilops cylindrica L.), medusahead (Taeniatherum caput-medusae [L.] Nevski), and ventenata (Ventenata dubia (Leers) Coss).

Herbicide efficacy may also be compared between sites with no remaining fine fuel in recently burned areas (natural or prescribed) and non-burned sites. The present inventors compare downy brome control in recently burned and unburned sites to determine the impact of thatch on indaziflam and imazapic behavior under field conditions. The relevance of greenhouse and laboratory experiments with real world experience may be evaluated by a lightning-caused wildfire that occurred in place, such as Jefferson, Colo. This burned area was heavily infested with downy brome and the downy brome residue was largely responsible for the fire's rapid expansion. Several hundred acres burned before the fire was extinguished. This provides a unique opportunity to use the burned and non-burned areas as the main factors in a split plot experiment to evaluate the impact of thatch on the performance of indaziflam and imazapic. Standard small plot techniques may be used to compare indaziflam at 3, 5, and 7 oz product/acre to imazapic at 6 and 12 oz product/acre. Herbicide applications may be made in early December. Each treatment may include glyphosate to control emerged downy brome. This site has good native vegetation. Residual downy brome control may be evaluated with and without thatch based on herbicide impacts on non-target species and the response of the native plant community to fire and herbicides in an integrated weed management strategy. These plots may be monitored for the next 3 to 4 years.

Advantages of the present disclosure may include the use of indaziflam alone or in combination with broadleaf herbicides to potentially extend control up to 4 YAT. For invasive winter annual grasses, such as downy brome, indaziflam may be applied alone pre-emergence. However, having limited post-emergence activity, indaziflam would often need to be used in combination with other broadleaf herbicides to control actively growing rosettes in the fall or spring. Indaziflam's residual activity could provide the necessary time for desired co-occurring species to re-establish. Thus, indaziflam can influence rangeland plant community assembly in areas affected by invasive species that take over native rangelands primarily by their high propagule pressure. Indaziflam could also be used in conjunction with other methods to shift the advantages from exotic invaders with high propagule pressure back toward the natives and other desirable vegetation. Because indaziflam has a unique mode of action (cellulose biosynthesis inhibitor) for non-crop weed management, combining indaziflam with other modes of action in a single treatment could also be used for resistance management and wildfire reduction.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for wildfire control in a habitat that contains or could contain plants susceptible to wildfire, comprising
applying to the habitat a composition comprising a cellulose biosynthesis inhibitor.

2. A method of controlling invasive plants in a habitat, comprising
applying to the habitat a composition comprising a cellulose biosynthesis inhibitor.

3. A method for residual control of invasive plants in a habitat, comprising
applying to the habitat a composition comprising a cellulose biosynthesis inhibitor.

4. The method of claim 1, wherein the cellulose biosynthesis inhibitor is applied to a plant, wherein the plant is at least one selected from the group consisting of blue grama (Bouteloua gracilis), buffalo grass (Bouteloua dactyloides), western wheatgrass (Pascopyrum smithii), bluebunch wheatgrass (Pseudoroegneria spicata), Griffith's wheatgrass (Agropyron griffithsii), sedges (Carex spp.), needle-and-thread (Hesperostipa comata), Columbia needlegrass (Achnatherum nelsonii), green needlegrass (Nassella viridula), Indian ricegrass (Oryzopsis hymenoides), big bluestem (Andropogon gerardi), little bluestem (Schizachyrium scoparium), sand bluestem (Andropogon hallii), switchgrass (Panicum virgatum), Parry oatgrass (Danthonia parryi), timber oatgrass (Danthonia intermedia), mountain muhly (Muhlenbergia montana), slim-stem muhly (Muhlenbergia filiculmis), Kentucky bluegrass (Poa pratensis), Sandberg bluegrass (Poa secunda), mountain brome (Bromus marginatus), nodding brome (Bromus anomalus), Indiangrass (Sorghastrum nutans), Idaho fescue (Festuca idahoensis), eastern gammagrass (Tripsacum dactyloides), prairie junegrass (Koeleria macrantha), sand lovegrass (Eragrostis trichodes), slender wheatgrass (Elymus trachycaulus), common mullein (Verbascum thapsus), common teasel (Dipsacus fullonum), curly dock (Rumex crispus), Dalmatian toadflax (Linaria dalmatica), diffuse knapweed (Centaurea diffusa), downy brome (Bromus tectorum), feral rye (Secale cereale), halogeton (Halogeton glomeratus), marestail (Conyza Canadensis), musk thistle (Carduus nutans), Louisiana sage (Artemisia ludoviciana), fringed sage (Artemisia frigida), common sunflower (Helianthus annuus), sulphur-flower buckwheat (Eriogonum umbellatum), and hairy goldenaster (Heterotheca villosa), Canada thistle (Cirsium arvense), teasel (Dipsacus spp.), Houndstongue (Cynoglossum officinale), scotch thistle (Onopordum acanthium), field bindweed (Convolvulus arvensis), American peavine (Vicia americana), and scarlet globemallow (Sphaeralcea coccinea).

5. The method of claim 1, wherein the plant is at least one selected from the group consisting of common mullein (Verbascum thapsus), common teasel (Dipsacus fullonum), curly dock (Rumex crispus), Dalmatian toadflax (Linaria dalmatica), diffuse knapweed (Centaurea diffusa), downy brome (Bromus tectorum), feral rye (Secale cereale), halogeton (Halogeton glomeratus), marestail (Conyza Canadensis), musk thistle (Carduus nutans), Louisiana sage (Artemisia ludoviciana), fringed sage (Artemisia frigida), common sunflower (Helianthus annuus), sulphur-flower buckwheat (Eriogonum umbellatum), and hairy goldenaster (Heterotheca villosa), Canada thistle (Cirsium arvense), teasel (Dipsacus spp.), Houndstongue (Cynoglossum officinale), scotch thistle (Onopordum acanthium), and field bindweed (Convolvulus arvensis).

6. The method of claim 1, wherein the plant is selected from the group consisting of Dalmatian toadflax (Linaria dalmatica) and downy brome (Bromus tectorum).

7. The method of claim 1, wherein the habitat is a non-crop area.

8. The method of claim 1, wherein the habitat is a rangeland or a pastureland.

9. The method of claim 1, wherein the cellulose biosynthesis inhibitor is applied at a rate of 1-1,000 g ai ha⁻¹.

10. The method of claim 1, wherein the composition further comprises at least one additional herbicide.

11. The method of claim 10, wherein the at least one additional herbicide is applied at a rate of 10-2,000 g ai ha⁻¹.

12. The method of claim 1, wherein the cellulose biosynthesis inhibitor is indaziflam.

13. The method of claim 10, wherein the at least one additional herbicide is selected from the group consisting of aminopyralid, aminocyclopyrachlor, imazapic, and picloram.

14. The method of claim 1, wherein the composition comprises indaziflam and aminopyralid.

15. The method of claim 1, wherein the composition comprises indaziflam and aminocyclopyrachlor.

16. The method of claim 1, wherein the composition comprises indaziflam and imazapic.

17. The method of claim 1, wherein the composition comprises indaziflam and picloram.

18. The method of claim 1, further comprises reducing germinating seedlings of the plant.

19. The method of claim 1, wherein the applying is once a year.

20. The method of claim 1, wherein the applying is every two years.
